(19) United States
(12) Patent Application Publication
(10) Pub. No.: US 2025/0340166 A1
(43) Pub. Date: Nov. 6, 2025

(54) VARIABLE INTENSITY BRAKE LIGHT SYSTEMS AND METHODS

(71) Applicant: Torc Robotics, Inc., Blacksburg, VA (US)

(72) Inventors: Akshay Pai Raikar, Blacksburg, VA (US); Garrett Madsen, Blacksburg, VA (US); Joseph R. Fox-Rabinovitz, Blacksburg, VA (US)

(21) Appl. No.: 18/654,476

(22) Filed: May 3, 2024

(51) Int. Cl. B60Q 1/44; B60Q 1/30

(52) U.S. Cl. CPC B60Q 1/444; B60Q 1/30

(57) ABSTRACT

A system for controlling brake lights is provided. The system includes a processor in communication with a memory. The processor is configured to detect a brake input level of a vehicle, the brake input level indicating a commanded amount of pressure to apply to brakes of the vehicle, determine an intensity level from a plurality of predefined intensity levels at which to control a variable intensity brake light based on the brake input level, and control the variable intensity brake light to operate at the determined intensity level.

### TECHNICAL FIELD

The field of the disclosure relates generally to light systems for vehicles and, more specifically, to variable intensity brake light systems.

### BACKGROUND OF THE INVENTION

Brake lights deliver information about whether a vehicle is standing, moving forward normally, or intentionally decelerating. Brake lights generally only have two states: ON when the vehicle's brakes are engaged, and OFF when the vehicle's brakes are not engaged. In some situations, it would be beneficial if brake lights were capable of conveying additional information about a status of the brakes. In particular, autonomous vehicles may benefit from this additional information for prediction and planning while driving. An improved brake light system is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system for controlling brake lights is provided. The system includes a processor in communication with a memory. The processor is configured to detect a brake input level of a vehicle, the brake input level indicating a commanded amount of pressure to apply to brakes of the vehicle, determine an intensity level from a plurality of predefined intensity levels at which to control a variable intensity brake light based on the brake input level, and control the variable intensity brake light to operate at the determined intensity level.

In another aspect, a method for controlling brake lights is provided. The method includes detecting a brake input level of a vehicle, the brake input level indicating a commanded amount of pressure to apply to brakes of the vehicle, determining an intensity level from a plurality of predefined intensity levels at which to control a variable intensity brake light based on the brake input level, and controlling the variable intensity brake light to operate at the determined intensity level.

In yet another aspect, a brake light system is provided. The brake light system includes a variable intensity brake light, a memory, and a processor in communication with the memory. The processor is configured to detect a brake input level of a vehicle, the brake input level indicating a commanded amount of pressure to apply to brakes of the vehicle, determine an intensity level from a plurality of predefined intensity levels at which to control the variable intensity brake light based on the brake input level, and control the variable intensity brake light to operate at the determined intensity level.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of a vehicle;

FIG. 2 is a block diagram of a vehicle;

FIG. 3 is a block diagram of a brake light control system;

FIG. 4 is a flow chart of a method for controlling brake lights of a vehicle; and

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The embodiments described herein include a system for controlling brake lights. The system includes a processor in communication with a memory. The processor is configured to detect a desired or commanded level of braking (referred to herein as “a brake input level”) of a vehicle. For example, the processor may be in communication with a sensor configured to detect a brake pedal position or brake pressure, or may receive a digital or analog braking command from a vehicle controller or brake-by-wire system (e.g., in cases in which the vehicle is an autonomous vehicle). Based on the detected brake input level, the processor is configured to determine an intensity level from a plurality of predefined intensity levels at which to control a variable intensity brake light and to control the variable intensity brake light to operate at the determined intensity level. For example, the variable intensity brake light may be fully illuminated when full braking is commanded, not illuminated when no braking is commanded, and illuminated at an intermediate level when an intermediate level of braking is applied. The intensity of the variable intensity brake lights can be varied, for example, by controlling a voltage or duty cycle supplied to the variable intensity brake lights, controlling a number of lights illuminated (e.g., in cases in which variable intensity brake lights), or actuating a filter capable of partially covering the lights.

For safety purposes, it is generally desirable that the brake lights produce at least some minimum threshold intensity of light whenever the brakes are applied, even if applied at a minimal level. Accordingly, in some embodiments, the system controls a constant intensity brake light separate from the variable intensity brake light to be illuminated when the brake input level is perceptibly greater than zero. Alternatively, in some embodiments, the variable intensity brake light is controlled to operate at least at a minimum threshold intensity (e.g., half of a maximum intensity of the variable intensity brake lights) when the brake input level is perceptibly greater than zero.

In some embodiments, the variable intensity brake light is configured to be interpretable by an autonomous vehicle. For example, the autonomous vehicle may be configured to determine the brake input level based upon the intensity level of the variable intensity brake light. Determining the brake input level of a preceding vehicle provides additional data that the autonomous vehicle can use to predict future behavior (e.g., deceleration) of a preceding vehicle and plan its own behavior accordingly.

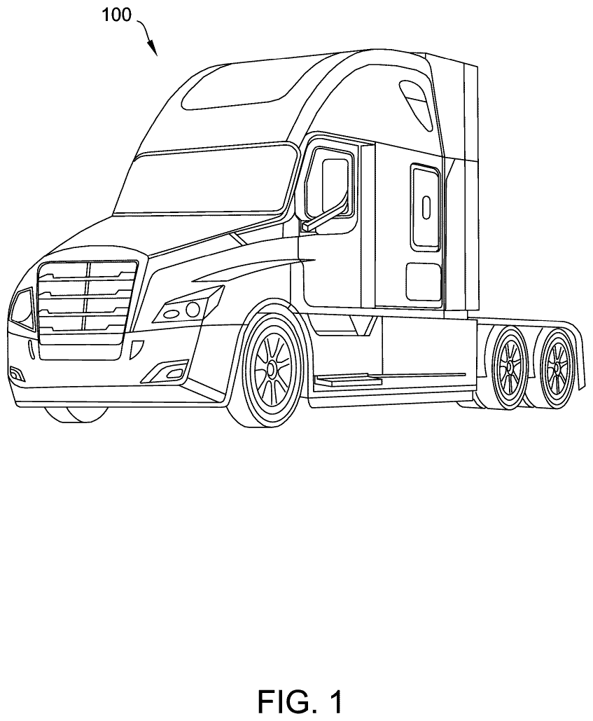

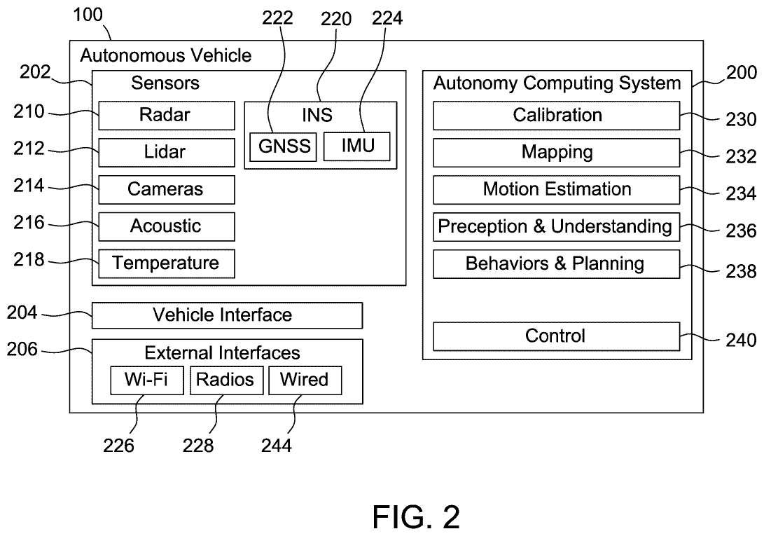

FIG. 1 is a schematic diagram of a vehicle 100. FIG. 2 is a block diagram of vehicle 100 shown in FIG. 1. In the example embodiment, vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of vehicle 100 and its proximity. As described in further detail below, these signals may be used by autonomy computing system 120 to determine how to control operation of vehicle 100.

Cameras 214 are configured to capture images of the environment surrounding vehicle 100 in any aspect or field of view (FOV). The FOV can have any angle or aspect such that images of the areas ahead of, to the side, behind, above, or below vehicle 100 may be captured. In some embodiments, the FOV may be limited to particular areas around vehicle 100 (e.g., forward of vehicle 100, to the sides of vehicle 100, etc.) or may surround 360 degrees of vehicle 100. In some embodiments, vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding vehicle 100. In some embodiments, the image data generated by cameras 214 may be sent to autonomy computing system 200 or other aspects of vehicle 100, and this image data may include vehicle 100 or a generated representation of vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around vehicle 100.

GNSS receiver 222 is positioned on vehicle 100 and may be configured to determine a location of vehicle 100, which it may embody as GNSS data, as described herein. GNSS receiver 222 may be configured to receive one or more signals from a global navigation satellite system (e.g., Global Positioning System (GPS) constellation) to localize vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of vehicle 100. For example, with two GNSS receivers 222, two attitude angles (e.g., roll and yaw) may be measured or determined. In some embodiments, vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about vehicle 100 and its environment.

IMU 224 is a micro-electrical-mechanical (MEMS) device that measures and reports one or more features regarding the motion of vehicle 100, although other implementations are contemplated, such as mechanical, fiber-optic gyro (FOG), or FOG-on-chip (SiFOG) devices. IMU 224 may measure an acceleration, angular rate, and or an orientation of vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of vehicle 100.

In the example embodiment, autonomy computing system 200 employs vehicle interface 204 to send commands to the various aspects of vehicle 100 that actually control the motion of vehicle 100 (e.g., engine, throttle, steering wheel, brakes, etc.) and to receive input data from one or more sensors 202 (e.g., internal sensors). External interfaces 206 are configured to enable vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of vehicle 100 or when downloading mission data after completion of a trip. The connection(s) may be used to download and install various lines of code in the form of digital files (e.g., HD maps), executable programs (e.g., navigation programs), and other computer-readable code that may be used by vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard vehicle 100.

Autonomy computing system 200 of vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

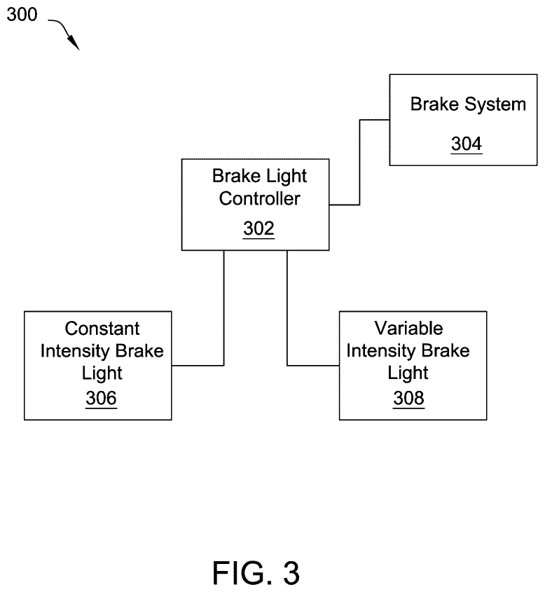

FIG. 3 is a block diagram of a brake light system 300 for use in vehicle 100 shown in FIG. 1. In the example embodiment, brake light system 300 includes a brake light controller 302, a brake system 304, at least one constant intensity brake light 306, and at least one variable intensity brake light 308. In embodiments in which vehicle 100 is an autonomous vehicle, at least some functions of brake light controller 302 may be performed by autonomy computing system 200. Constant intensity brake light 306 and variable intensity brake light 308 may include traditional (e.g., red-colored) light sources or alternative light sources, such as those of different colors or those not perceptible to the human eye (e.g., infrared light sources). In some embodiments, constant intensity brake light 306 and variable intensity brake light 308 are different light sources.

In the example embodiment, brake light controller 302 is configured to detect a brake input level of vehicle 100. The brake input level indicates a desired or commanded amount of pressure to apply to brakes of vehicle 100 using brake system 304. For example, brake light controller 302 may detect a position of a brake pedal, a fluid pressure of a master cylinder or other portion of brake system 304, a digital braking command generated by a brake-by-wire system or autonomy computing system 200, a force applied at or position of brake calipers or brake pads, or other properties of brake system 304 that indicate a desired or commanded amount of braking. The brake input level can be expressed as a percentage, with zero percent representing no application of the brakes and one hundred percent representing full application of the brakes.

In the example embodiment, brake light controller 302 determines an intensity level at which to control constant intensity brake light 306 and variable intensity brake light 308. Like a traditional brake light, constant intensity brake light 306 is controlled to be illuminated at a constant intensity during any application of the brakes of brake system 304. In other words, constant intensity brake light 306 is fully illuminated whenever the brake input level is greater than zero. Illuminating constant intensity brake light 306 ensures at least some threshold intensity is met during braking that is perceptible to human observers or autonomy systems (e.g., similar to autonomy computing system 200) of other vehicles.

Variable intensity brake light 308 is controlled to operate a plurality of predefined intensity levels. These intensity levels include a zero intensity, where variable intensity brake light 308 is off, a maximum intensity, where variable intensity brake light 308 is fully illuminated, and one or more intermediate intensities. In certain embodiments, a predefined relationship between brake input levels and intensity levels is stored in a memory (e.g., as a lookup table), and brake light controller 302 performs a lookup to determine an intensity level at which to operate variable intensity brake light 308. For example, the intensity at which brake light controller 302 controls variable intensity brake lights 308 to operate may be linearly proportional or otherwise proportional to the detected brake input level.

For example, a detected brake input level may be zero, minimal (i.e., slightly greater than zero), intermediate (i.e., somewhere between minimal and full), or full (i.e., maximum braking force is commanded). At a brake input level of zero, both constant intensity brake light 306 and variable intensity brake light 308 are off. At a minimal brake input level, constant intensity brake light 306 is fully illuminated and variable intensity brake light 308 is off. At an intermediate brake input level, constant intensity brake light 306 is fully illuminated and variable intensity brake light 308 is illuminated at an intermediate intensity level. At a full brake input level, both constant intensity brake light 306 and variable intensity brake light 308 are fully illuminated.

In some alternative embodiments, no constant intensity brake light 306 is present. In such embodiments, variable intensity brake light 308 is illuminated to some minimal threshold level (e.g., at least half of full intensity) whenever the brakes or applied. For example, in such embodiments, at a brake input level of zero, variable intensity brake light 308 is off, at a minimal brake level, variable intensity brake light 308 is illuminated at the minimum threshold level (e.g., half of full intensity), at an intermediate brake level, variable intensity brake light 308 is illuminated at an intensity between the minimum threshold level and full intensity, and at a full brake input level, variable intensity brake light 308 is fully illuminated.

In the example embodiment, brake light controller 302 is configured to control variable intensity brake light 308 to operate at the determined intensity. For example, brake light controller 302 may control a voltage of power supplied to variable intensity brake light 308, control a filter that adjusts an intensity output of variable intensity brake light 308 (e.g., by covering a light source to a selective degree), or in cases where variable intensity brake light 308 includes multiple discrete light sources, may control a number of these light sources that are illuminated. In some embodiments, variable intensity brake light 308 includes a local processor configured to receive an analog or digital intensity command from variable intensity brake light 308 and control variable intensity brake light 308 to operate at the commanded intensity.

In some embodiments, an intensity of constant intensity brake light 306 and variable intensity brake light 308 can be perceived and interpreted by another vehicle (e.g., similar to vehicle 100) to determine a level of braking of brake system 304 and, based on this level, predict a deceleration of a vehicle 100 in which brake light system 300. This prediction can be used as a factor in controlling the other vehicle.

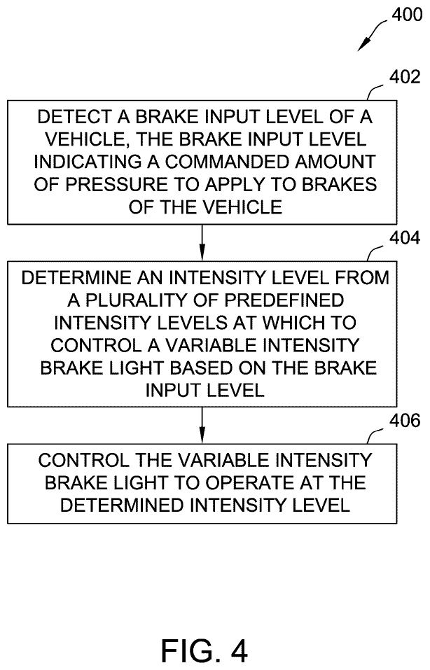

FIG. 4 is a flowchart of an example method 400 for controlling brake lights. In the example embodiment, method 400 is performed using brake light system 300 (shown in FIG. 3. Brake light controller 302 detects 402 a brake input level of a vehicle. The brake input level indicating a commanded amount of pressure to apply to brakes of the vehicle. Brake light controller 302 determines 404 an intensity level from a plurality of predefined intensity levels at which to control variable intensity brake light 308 based on the brake input level. Brake light controller 302 controls 406 variable intensity brake light 308 to operate at the determined intensity level.

In some embodiments, the plurality of predefined intensity levels includes a minimum intensity level, a maximum intensity level, and at least one intermediate intensity level between the minimum intensity level and the maximum intensity level.

In some embodiments, brake light controller 302 determines the brake input level is greater than zero and controls constant intensity brake light 306 to illuminate when the brake input level is greater than zero.

In some embodiments, brake light controller 302 determines the brake input level is greater than zero and controls variable intensity brake light 308 to operate at least at a minimum threshold intensity level when the brake input level is greater than zero. In some such embodiments, the minimum threshold intensity level is at least half of a maximum intensity level of variable intensity brake light 308.

In some embodiments, to determine the intensity level, brake light controller 302 performs a lookup using the lookup table based on the brake input level, the lookup table defining a relationship between the brake input level and the intensity level.

In some embodiments, variable intensity brake light 308 is interpretable by an autonomous vehicle (such as vehicle 100) to determine the brake input level based upon the intensity level of variable intensity brake light 308.

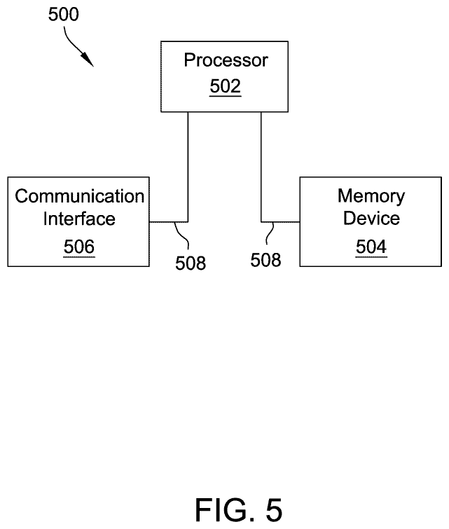

FIG. 5 is a block diagram of an example computing device 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) improving an amount of information conveyable by a brake light by controlling an intensity of the brake light based on a brake input level; (b) enabling increased visibility of brake light systems including variable intensity brake lights by operating the brake light system at a minimum threshold intensity when brakes are engaged; or (c) ability for autonomous vehicles to determine a braking level of another vehicle by interpreting brake lights on the other vehicle controlled to vary intensity based on a braking level.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for controlling brake lights, the system comprising a processor in communication with a memory, the processor configured to:
detect a brake input level of a vehicle, the brake input level indicating a commanded amount of pressure to apply to brakes of the vehicle;
determine an intensity level from a plurality of predefined intensity levels at which to control a variable intensity brake light based on the brake input level; and
control the variable intensity brake light to operate at the determined intensity level.

2. The system of claim 1, wherein the plurality of predefined intensity levels includes a minimum intensity level, a maximum intensity level, and at least one intermediate intensity level between the minimum intensity level and the maximum intensity level.

3. The system of claim 1, wherein the processor is further configured to:
determine the brake input level is greater than zero; and
control a constant intensity brake light to illuminate when the brake input level is greater than zero.

4. The system of claim 1, wherein the processor is further configured to:
determine the brake input level is greater than zero; and
control the variable intensity brake light to operate at least at a minimum threshold intensity level when the brake input level is greater than zero.

5. The system of claim 4, wherein the minimum threshold intensity level is at least half of a maximum intensity level of the variable intensity brake light.

6. The system of claim 1, wherein a lookup table defining a relationship between the brake input level and the intensity level is stored in the memory, and wherein to determine the intensity level, the processor is configured to perform a lookup using the lookup table based on the brake input level.

7. The system of claim 1, wherein the variable intensity brake light is interpretable by an autonomous vehicle to determine the brake input level based upon the intensity level of the variable intensity brake light.

8. A method for controlling brake lights, the method comprising:
detecting a brake input level of a vehicle, the brake input level indicating a commanded amount of pressure to apply to brakes of the vehicle;
determining an intensity level from a plurality of predefined intensity levels at which to control a variable intensity brake light based on the brake input level; and
controlling the variable intensity brake light to operate at the determined intensity level.

9. The method of claim 8, wherein the plurality of predefined intensity levels includes a minimum intensity level, a maximum intensity level, and at least one intermediate intensity level between the minimum intensity level and the maximum intensity level.

10. The method of claim 8, further comprising:
determining the brake input level is greater than zero; and
controlling a constant intensity brake light to illuminate when the brake input level is greater than zero.

11. The method of claim 8, further comprising:
determining the brake input level is greater than zero; and
controlling the variable intensity brake light to operate at least at a minimum threshold intensity level when the brake input level is greater than zero.

12. The method of claim 11, wherein the minimum threshold intensity level is at least half of a maximum intensity level of the variable intensity brake light.

13. The method of claim 8, wherein determining the intensity level comprises performing a lookup using a lookup table based on the brake input level, the lookup table defining a relationship between the brake input level and the intensity level.

14. The method of claim 8, wherein the variable intensity brake light is interpretable by an autonomous vehicle to determine the brake input level based upon the intensity level of the variable intensity brake light.

15. A brake light system comprising:
a variable intensity brake light;
a memory; and
a processor in communication with the memory, the processor configured to:
detect a brake input level of a vehicle, the brake input level indicating a commanded amount of pressure to apply to brakes of the vehicle;
determine an intensity level from a plurality of predefined intensity levels at which to control the variable intensity brake light based on the brake input level; and
control the variable intensity brake light to operate at the determined intensity level.

16. The brake light system of claim 15, wherein the plurality of predefined intensity levels includes a minimum intensity level, a maximum intensity level, and at least one intermediate intensity level between the minimum intensity level and the maximum intensity level.

17. The brake light system of claim 15, further comprising a constant intensity brake light, wherein the processor is further configured to:
determine the brake input level is greater than zero; and
control the constant intensity brake light to illuminate when the brake input level is greater than zero.

18. The brake light system of claim 15, wherein the processor is further configured to:
determine the brake input level is greater than zero; and
control the variable intensity brake light to operate at least at a minimum threshold intensity level when the brake input level is greater than zero.

19. The brake light system of claim 18, wherein the minimum threshold intensity level is at least half of a maximum intensity level of the variable intensity brake light.

20. The brake light system of claim 15, wherein a lookup table defining a relationship between the brake input level and the intensity level is stored in the memory, and wherein to determine the intensity level, the processor is configured to perform a lookup using the lookup table based on the brake input level.
